(19) United States
(12) Patent Application Publication
(10) Pub. No.: US 2005/0285884 A1
(43) Pub. Date: Dec. 29, 2005

(54) Network-based information recording/reproducing system, information transmission destination retrieval method, and information recording/reproducing apparatus

(75) Inventor: Hajime Suda, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/138,451

(22) Filed: May 27, 2005

(30) Foreign Application Priority Data
Jun. 29, 2004 (JP) 2004-192272

(51) Int. Cl. B41J 29/38

(52) U.S. Cl. 347/5

(57) ABSTRACT

Disclosed is a network-based information recording/reproducing system, in which a first information recording/reproducing apparatus being a sender of an information transmits an information transfer request information containing a transaction ID to all the information recording/reproducing apparatus(es) connected via a network except the first apparatus itself; out of the information recording/reproducing apparatus (es) received such a transmission, a second information recording/reproducing apparatus applicable to the information transfer request transmits (for example, unicasts) an information transfer response information containing the transaction ID, a hostname/IP address information of itself, and an information medium type information indicating the type of an information medium device; the first apparatus receiving the response information transmits an information content to the second apparatus specified by the hostname/IP address information contained in the response information; and the second apparatus records the received information content into a first or second medium specified by the medium type information.

### CROSS-REFERENCE TO THE APPLICATIONS

This application is based upon and claims the benefit of priority from the prior Japanese Patent Application No. 2004-192272, filed on Jun. 29, 2004; the entire contents of which are incorporated herein by reference.

### BACKGROUND

1. Field of the Invention

The present invention relates to a network-based information recording/reproducing system, an information transmission destination retrieval method, and an information recording/reproducing apparatus, and particularly to, a network-based information recording/reproducing system, an information transmission destination retrieval method, and an information recording/reproducing apparatus that retrieve via a network an apparatus capable of dubbing a video content therein.

2. Description of the Related Art

In recent years, a variety of video recording/reproducing apparatuses including a DVD (Digital Versatile Disk) player/recorder are coming into widespread use in the world around us including households (refer, for example, to Patent document 1 below).

In particular, DVDs exhibiting high information storing capabilities have been researched and developed for higher density and speed, and have been producing certain results. In the meantime, on the back of the unification of standards in an aim for a global standard, the development of the apparatuses has been making progress, and realized further usable and unified apparatuses.

Further, among the DVD players/recorders, for example, a technology for equipping a hard disk drive and a DVD drive together and recording a video and audio recorded in the hard disk into the DVD has been developed, serving to users in view of usability.

[Patent document 1] Japanese Patent Laid-open Application No. 2002-091409.

However, the video recording function of the conventional video recording/reproducing apparatuses such as the DVD player/recorder is limited to that transmits/receives the video and audio information within the same apparatus.

### SUMMARY

The present invention has been made to bring a solution to the above-described problem of the conventional arts, and an object thereof is to provide a network-based information recording/reproducing system, an information transmission destination retrieval method, and an information recording/reproducing apparatus capable of dubbing a video content among a plurality of apparatuses via a network.

In more detail, an object of the present invention is to provide a network-based information recording/reproducing system, an information transmission destination retrieval method, and an information recording/reproducing apparatus that retrieve via a network an apparatus capable of dubbing a video content therein when dubbing the video content among a plurality of apparatuses via the network.

It is therefore an object of the present invention to provide an information recording/reproducing system, an information transmission destination retrieval method, and an information recording/reproducing apparatus that are further convenient and usable for users by providing such a network-based information recording/reproducing system and information recording/reproducing apparatus.

According to an aspect of the present invention, there is provided a network-based information recording/reproducing system having a plurality of information recording/reproducing apparatuses, each of which is provided with at least a central processing unit (CPU), first and/or second information medium device(s), and a communication unit, connected via a network to transmit/receive information including video among the information recording/reproducing apparatuses, in which a first recording/reproducing apparatus being a transmitter of the information transmits (for example, broadcasts) an information transfer request information containing a transaction ID to the information recording/reproducing apparatus (es) connected via the network other than the first recording/reproducing apparatus itself; a second information recording/reproducing apparatus applicable to an information transfer request, out of the information recording/reproducing apparatuses to which the information transfer request information is transmitted (for example, broadcasted), transmits (for example, unicasts) an information transfer response information containing the transaction ID, a host name/IP address information of the second information recording/reproducing apparatus and an information medium type information indicating a type of the information medium device to the first information recording/reproducing apparatus; the first information recording/reproducing apparatus receiving the information transfer response information transmits an information content to the second information recording/reproducing apparatus identified by the host name/IP address information contained in the information transfer response information; and the second information recording/reproducing apparatus records the transmitted information content into a first or second information medium specified by the information medium type information.

According to the present invention configured in the above-described manner, the first information recording/reproducing apparatus being the transmitter and source of the information can confirm whether or not the information transfer response information transmitted thereto via the network is a response related to the transfer request of itself by checking whether or not the information transfer response information includes the transaction ID transmitted by itself, and at the same time, the second information recording/reproducing apparatus being a transmission destination can be identified by the host name/IP address information contained in the information transfer response information, allowing the information content to be transmitted only to a desired apparatus correctly even under the environment where a plurality of apparatuses are connected via the network. In addition to that, the information transfer response information, which is an information at the first response to the transmission (for example, a broadcast) from the first information recording/reproducing apparatus, contains the information medium type information, so that the transactions related to the information content transmission is reduced by one time, allowing a high speed content transmission to be realized.

According to another aspect of the present invention, there is provided an information transmission destination retrieval method to specify a transmission destination so as to transmit an information content to an information recording/reproducing apparatus provided with at least a central processing unit (CPU), first and/or second information medium device(s), and a communication unit, and connected via a network, comprising: transmitting (for example, broadcasting) an information transfer request information containing a transaction ID to the network; receiving an information transfer response information containing an host name/IP address information, the transaction ID, and an information medium type information indicating a type of the information medium device that are related to the information recording/reproducing apparatus responding to the transmitted (for example, proadcasted) information transfer request information transmitted; and specifying the information recording/reproducing apparatus as a transmission destination of information and the information medium device related to the information recording/reproducing apparatus, based on the transaction ID contained in the information transfer response information.

According to the present invention configured in the above-described manner, it is possible to confirm whether or not the information transfer response information transmitted via the network is the response related to the transmission request from the transmitter apparatus, by checking whether or not the information transfer response information contains the transaction ID transmitted by the transmitter apparatus, and at the same time, the information recording/reproducing apparatus as the transmission destination can be identified by the host name/IP address information contained in the information transfer response information, so that the desired destination apparatus for the transmission can be specified correctly even under the environment where a plurality of apparatus are connected via the network. Also, the information transfer response information contains the information medium type information, so that the record medium type in the desired destination apparatus for the transmission can be specified at the same time, without the need of any additional procedure to specify the medium type, so that the transactions related to the information content transmission is reduced by one time, allowing a high speed content transmission to be realized.

According to still another aspect of the present invention, there is provided an information recording/reproducing apparatus provided with at least a central processing unit (CPU), first and/or second information medium device(s), and a communication unit, in which the central processing unit includes: an information transfer request information broadcast means for transmitting via the communication unit an information transfer request information containing a transaction ID for an information content transmission to another information recording/reproducing apparatus connected therewith via a network; a verification means for verifying the transaction ID contained in the information transfer request information received via the communication unit; an information transfer response means for transmitting (for example, unicasts) an information transfer response information containing the transaction ID, an IP address information of itself, and an information medium type information indicating a type of the information medium device, to an information recording/reproducing apparatus being a transmitter of the information transfer request information, when the information transfer request information is verified to be applicable to itself by the verification means; an information content transmission means for transmitting an information content to the information recording/reproducing apparatus being a transmission destination specified by the IP address information contained in the information transfer response information received; and a record means for recording the transmitted information content into a first or second information medium specified by the information medium type information.

According the present invention thus configured, the verification means verifies whether or not the information transfer response information contains the transaction ID transmitted by itself, allowing whether or not the information transfer response information is in response to the transfer request transmitted by itself to be confirmed, and the host name/IP address information also contained therein enables the information content transmission means to specify the information recording/reproducing apparatus as a transmission destination, so that the information recording/reproducing apparatus transmitting the information content only to the desired apparatus correctly even under the environment where a plurality of apparatuses are connected via the network can be realized. In addition, the information transfer response information, which is an information at the first response to the transmission (for example, a broadcast) from the information recording/reproducing apparatus being the transmitter, contains the information medium type information, allowing the transactions related to the information content transmission to be reduced by one time, so that the information recording/reproducing apparatus capable of performing a high speed content transmission can be realized.

In the above cases, the “information” of the “information content” includes video, audio, and data, as a concept. The “information recording/reproducing apparatus” means those apparatuses equipped with a certain drive for a record media and having an information recording and reproducing function, including, for example, an apparatus having a video recording/reproducing function to/from a DVD.

Further, in the CPU related to the above-described information recording/reproducing apparatus, the “information transfer request broad cast means”, “verification mean”, “information transfer request response means”, “information content transmission means”, and “record means” are realizable by a circuit, logic design, software, chip or record medium mounting the software thereon, or the like realizing the corresponding above-mentioned functions. This is also applicable to a “means for registering a group ID information” and “means for registering an information transfer request acceptable/unacceptable information” which will be described later.

The present invention has an advantage that the desired apparatus as a transmission destination can be specified correctly even under the environment where a plurality of apparatuses are connected via the network, in that whether or not the information transfer response information transmitted via the network is the response to the transfer request transmitted by the transmitter apparatus can be confirmed, by checking whether or not the information transfer response information contains the transaction ID transmitted by the transmitter apparatus, and at the same time, the host name/IP address information also contained therein enables to specify the information recording/reproducing apparatus as a transmission destination.

### BRIEF DESCRIPTION OF THE DRAWINGS

FIG. 1 is a block diagram showing an overall configuration of a network-based information recording/reproducing system according to an embodiment of the present invention.

FIG. 2 is a block diagram showing an overall configuration of the network-based information recording/reproducing system according to an embodiment of the present invention when any natural number “n” units are connected.

FIG. 3 is a block diagram showing a further detail functional configuration of a CPU 101 according to an embodiment of the present invention.

FIG. 4 is a timing and float chart combined with a screen transition chart showing operations of a video recording/reproducing apparatus and a network-based information recording/reproducing system according to an embodiment of the present invention, together with an order of screens appearing in response to the respective operations.

FIG. 5 is a view showing an example initial setting screen according to an embodiment of the present invention.

FIG. 6 is a view showing an example instruction input screen for registration according to an embodiment of the present invention.

FIG. 7 is a view showing an example initial setting screen according to an embodiment of the present invention.

FIG. 8 is a view showing an example instruction input screen for registration according to an embodiment of the present invention.

FIG. 9 is a view showing an example content selection screen according to an embodiment of the present invention.

FIG. 10 is a view showing an example information transfer type designation screen according to an embodiment of the present invention.

FIG. 11 is a schematic view showing a concept of a configuration of an information transfer request information to be broadcasted from a content transmitter according to an embodiment of the present invention.

FIG. 12 is a schematic view showing a concept of a configuration of an information transfer response information 1200 to be unicasted from a content transmission destination according to an embodiment of the present invention.

FIG. 13 is a schematic screen view showing an example display of a host name/IP address information and an information medium type information of an opposite party according to an embodiment of the present invention.

FIG. 14 is a view showing an example screen indicating that the content is now being transmitted.

FIG. 15 is a view showing an example screen indicating that the content is now being transmitted.

FIG. 16 is a view showing an example screen when the content dubbing (copying) is completed.

FIG. 17 is a schematic timing chart showing a concept of broadchast/unicast in the case where a plurality of apparatuses are connected to a network according to an embodiment of the present invention.

### DETAILED DESCRIPTION

(Explanation of Embodiments)

Embodiments according to the present invention will be described with reference to the drawings, however, the drawings are provided only for the purpose of illustration and in no case limit the invention.

As a form of an embodiment of the present invention as an information recording/reproducing system, it is possible to configure such that respective information recording/reproducing apparatuses belonging to a network register respectively a group ID information identifying the respective groups to which they belong prior to transmitting (for example, broadcasting) an information transfer request information; the information transfer request information contains the group ID information; and a second information recording/reproducing apparatus receiving the information transfer request information transmitted (for example, broatcasted) from a first information recording/reproducing apparatus transmits (for example, unicasts) an information transfer response information to the first information recording/reproducing apparatus only when the group ID information received matches with the group ID information that is previously registered by the second information recording/reproducing apparatus itself.

With this configuration, it is possible to realize a content transmission system capable of preventing such an event from occurring that video information is transferred to an unexpected apparatus by mistake or intentionally, by allowing the content transmission only for those having the same group name and not for the other(s).

Further, as a form of an embodiment of the present invention as an information recording/reproducing system, it is possible to configure such that the respective information recording/reproducing apparatuses belonging to a network register an information transfer request acceptable/unacceptable information specifying whether or not to accept the information transfer request from the other apparatus prior to transmitting (for example, broadcasting) the information transfer request information, the second information recording/reproducing apparatus receiving the information transfer request information transmitted (for example, broatcasted) from the first information recording/reproducing apparatus transmits (for example, unicasts) the information transfer response information to the first information recording/reproducing apparatus only when the information transfer request acceptable/unacceptable information that the second information recording/reproducing apparatus itself previously registered is “acceptable”.

With this configuration, it is possible to realize a content transmission system capable of preventing the content transmission to the apparatus not desiring to accept the content due to other factor even when the apparatus has the same group name, by setting “unacceptable” to the information transfer request acceptable/unacceptable information, and in other words, a content transmission system with security can be realized.

Still further, the information transfer response information may be obtained by replacing a specified bit of the information transfer request information with a bit relating to an information medium type information.

With this configuration, it is possible to match the protocols of the information transfer request information transmitted (for example, broadcasted) and the information transfer response information transmitted (for example, unicasted) back thereto, serving to simplify a logical circuit, so that an information content can be transmitted correctly with high speed without experiencing any additional procedure.

Still further, the information transfer response information and the information transfer request information may be encrypted by a predetermined encryption method as a configuration.

With this configuration, even when a malicious network pirate exists, it is possible to prevent such an event from occurring that the video information is transferred to an unintended destination, so that a content transmission system with high security can be realized.

Still further, as a form of an embodiment of the present invention as an information transmission destination retrieval method, it may be configured to include registering the group ID information identifying the group name to which the respective information recording/reproducing apparatuses themselves belong before transmitting (for example, broadcasting) the information transfer request information, in which the information transfer request information has the group ID information, and the information recording/reproducing apparatus as a content receiver transmits back the information transfer response information only when the group ID information contained in the information transfer request information transmitted (for example, broadcasted) thereto matches with the group ID information related to itself. Further, the method may be configured to include registering the information transfer request acceptable/unacceptable information identifying whether or not to accept the information transfer request from the other apparatus belonging to the network prior to transmitting (for example, broadcasting) the information transfer request information, in which the information recording/reproducing apparatus as a content receiver transmits back the information transfer response information only when the registered information transfer request acceptable/unacceptable information of itself is “acceptable”. With this configuration, the above-described information transmission destination retrieval method can expect further improvement in accuracy.

Further more, the information transfer response information may be configured to be obtained by replacing a specified bit of the information transfer request information with a bit relating to the information medium type information. Further, the information transfer response information and the information transfer request information may be configured to be encrypted by a predetermined encryption method. With these configurations, the above-described information transmission destination retrieval method can be simplified further by eliminating additional step or can realize further improvement in security.

Still further, as a form of an embodiment of the present invention as an information recording/reproducing apparatus, it may be configured such that the central processing unit further includes a means for registering the group ID information identifying the group name to which the apparatus of the CPU itself belongs in the network, in which the information transfer request information contains the group ID information, and an information transfer response means transmits (for example, unicasts) the information transfer response information to the information recording/reproducing apparatus being the transmitter of the information transfer request information only when the group ID information of the information transfer request information received matches with the group ID of previously registered. Moreover, the central processing unit further includes a means for registering an information transfer request acceptable/unacceptable information identifying whether or not to accept the information transfer request information transmitted from the other information recording/reproducing apparatus in the network, in which the information transfer response means transmits (for example, unicasts) the information transfer response information to the information recording/reproducing apparatus being the transmitter of the information transfer request information only when the information transfer request acceptable/unacceptable information indicates “acceptable”. With these configurations, in the above-described information recording/reproducing apparatus, it is possible to prevent an event that the video information is transmitted by mistake or intentionally to an unexpected apparatus, so that security can be improved further.

Still further, the information transfer response information may be configured to be obtained by replacing a specified bit of the information transfer request information with a bit related to information medium type information. Further, the information transfer response information and the information transfer request information may be configured to be encrypted by a predetermined encryption method. With these configurations, in the above-described information recording/reproducing apparatus, it is possible by eliminating an additional procedure to realize a further correct and high speed information content transmission and a content transmission with high security.

Based on the above description, an embodiment according to the present invention will be described with reference to the drawings.

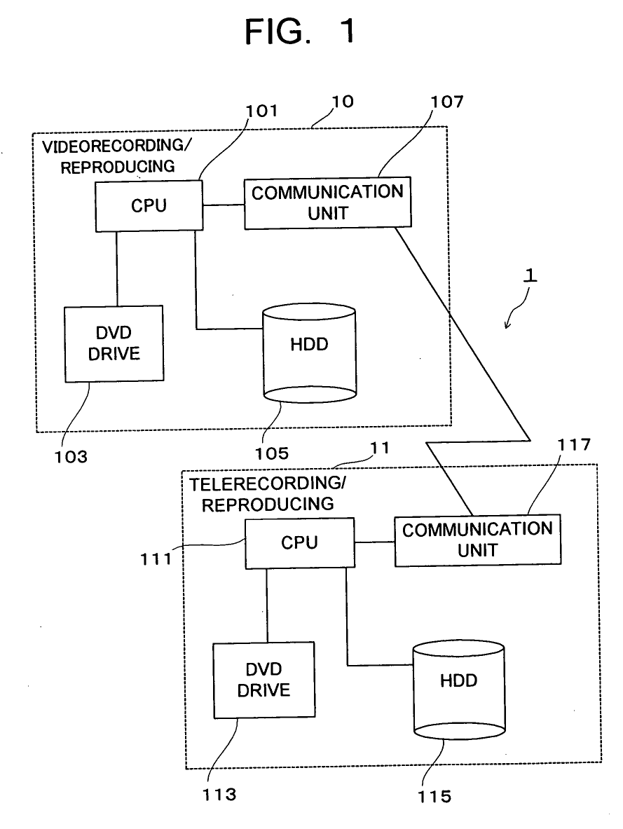

FIG. 1 is a block diagram showing an overall configuration of a network-based information recording/reproducing system according to an embodiment of the present invention. Note that, in the description below, the range required to attain the object of the present invention will be shown schematically, and the range corresponding to the present invention will be primarily described, so that the parts omitted in the description are assumed to be enabled by publicly known arts.

As shown in the drawing, a network-based information recording/reproducing system 1 according to an embodiment of the present invention is configured by connecting a video recording/reproducing apparatus (also called and sometimes described as “recording/reproducing apparatus”, and this is applicable hereinafter in the similar fashion) 10 and a video recording/reproducing apparatus 11 via a network, which have a configuration (which will be described later) specific to the present invention. Hereinafter, the respective components will be described by citing the case of the video recording/reproducing apparatus 10 as an example. As shown in FIG. 1, the video recording/reproducing apparatus 10 according to an embodiment of the present invention is composed of at least a CPU 101, a DVD drive 103 and a HDD (hard disk drive) 105 that are connected to the CPU 101 via a bus, and a communication unit 107 connected to the CPU 101 and also to the network with or without a wire. Similarly, the video recording/reproducing apparatus 11 is composed of at least a CPU 111, a DVD drive 113 and a HDD 115 that are connected to the CPU 111 via a bus, and a communication unit 117 connected to the CPU 111 and also to the network with or without a wire.

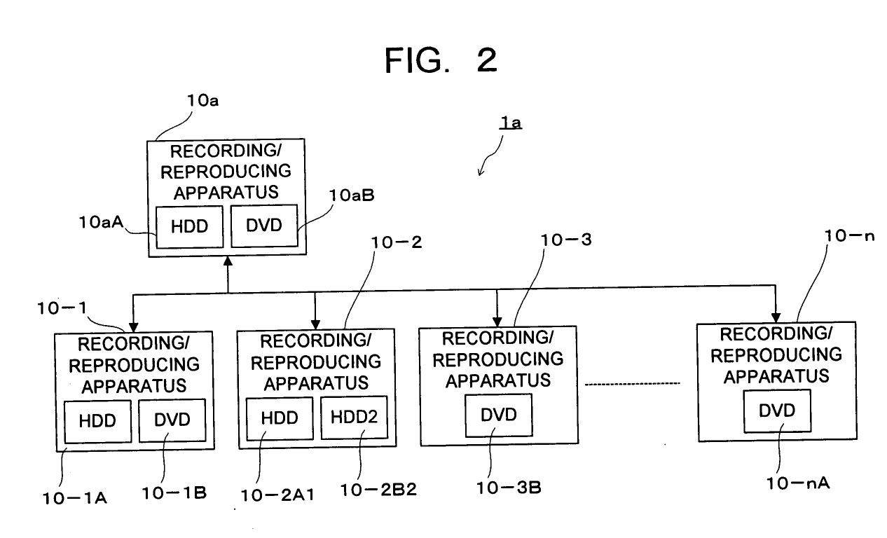

Note that, for the purpose of mainly describing the relation between the video recording/reproducing apparatus 10 and the video recording/reproducing apparatus 11, the network-based information recording/reproducing system is assumed to have two units of video recording/reproducing apparatuses as components here, however, the number of the components of such a system is not limited to two or any number, and the spirit of the present invention is applicable to the case where any natural number “n” units of such components are connected as shown, for example, in FIG. 2. More specifically, in the case shown in FIG. 2, a network-based information recording/reproducing system 1a according to the embodiment may be composed of a video recording/reproducing apparatus 10a, a video recording/reproducing apparatus 10-1, a video recording/reproducing apparatus 10-2, a video recording/reproducing apparatus 10-3, . . . , and a video recording/reproducing apparatus 10-n that are connected to each other via a network. The video recording/reproducing apparatus 10a includes a HDD 10aA and a DVD drive 10aB, the video recording/reproducing apparatus 10-1 includes a HDD 10-1A and a DVD drive 10-1B, the video recording/reproducing apparatus 10-2 includes a HDD 10-2A1 and a HDD 10-2A2, the video recording/reproducing apparatus 10-3 includes a DVD drive 10-3B, . . . , and the video recording/reproducing apparatus 10-n includes a HDD 10-nA. Thus, in the embodiment, any video recording/reproducing apparatus is acceptable as long as it is provided with both the HDD (hard disk drive) and the DVD drive (the unit number is any number equals to one or more), or any one of the two types of drives (the unit number is any number equals to one or more), as a recording medium.

Back to FIG. 1, the CPU 101 controls entire operation of the system, and executes an operating system stored in a (not shown) system memory, a target application program and so forth. The DVD drive 103 has function(s), based on an instruction from the CPU 101, to reproduce information written in a (not shown) DVD and/or to write information acquired via the communication unit 107 into the DVD.

The HDD 105 has function(s), based on an instruction from the CPU 101, to reproduce information written in a (not shown) hard disk and/or to write information acquired via the communication unit 107 into the hard disk. The communication unit 107 transmits/receives information to/from the other apparatus (the video recording/reproducing apparatus 11, here) connected via the network.

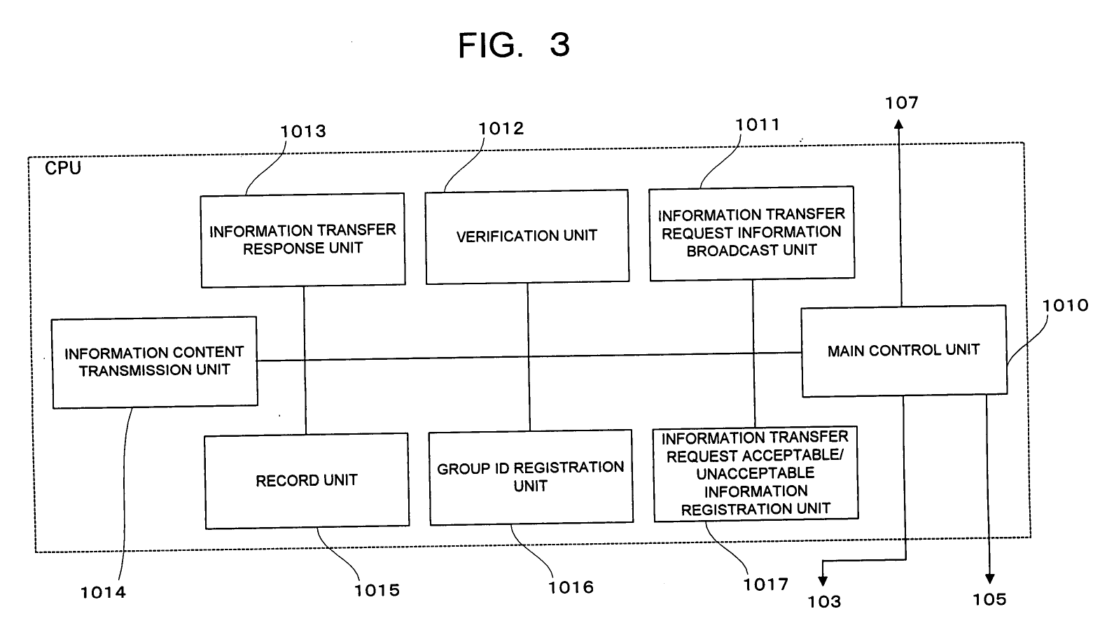

Subsequently, the description will be given in more detail of the configuration, which is specific to the embodiment, of the CPU 101. FIG. 3 is a block diagram showing a further detailed functional configuration of the CPU 101 according to an embodiment of the present invention. As shown in the drawing, the CPU 101 is composed of, at least, a main control unit 1010, an information transfer request information broadcast unit 1011, a verification unit 1012, an information transfer response unit 1013, an information content transmission unit 1014, a record unit 1015, a group ID information registration unit 1016, and an information transfer request acceptable/unacceptable information registration unit 1017. These respective units 1010 to 1017 are realized as a logical design of a circuit or a software (code) that realizes respective applicable functions described below, or otherwise realized by a chip, a record medium or the like mounting the software thereon.

The main control unit 1010 has functions to perform an overall control, to output a message required for a screen (which will be described later), and to accept an information inputted by a user.

The information transfer request information broadcast unit 1011 has functions to generate the information transfer request information containing a transaction ID (with a group name and a password) to the video recording/reproducing apparatus 11 connected thereto via the network for a (later described) information content transmission, and to broadcast the information via the communication unit 107.

The verification unit 1012 has functions to verify the information transfer request information received via the communication unit 107, to compare the (later-described) group name and password contained in the information transfer request information with the group name and password related to and registered by the apparatus thereof, and to determine a destination apparatus (here, 11) to transmit based on the transaction ID contained in the information transfer request information.

The information transfer response unit 1013 has functions: to generate an information transfer response information containing the transaction ID, a (later-described) host name/IP address information of the apparatus thereof, and a (later-described) information medium type information indicating the type of an information medium device, when the verification unit 1012 determines that the information transfer request information is applicable to its apparatus (specifically, the group name and password contained in the information transfer request information matches with the group name and password related to its apparatus); and to unicast (return) the generated information transfer response information to the video recording/reproducing apparatus 11.

The information content transmission unit 1014 has a function to transmit the information content to the video recording/reproducing apparatus 11 being the transmission destination specified by the host name/IP address information contained in the information transfer response information.

The record unit 1015 has a function to record the information content transmitted from the other information recording/reproducing apparatus (for example, the video recording/reproducing apparatus 11), into an information medium specified by the information medium type information, namely a DVD or a hard disk, when the video recording/reproducing apparatus 10 is a receiver of the information content.

The group ID registration information unit 1016 has functions to register the group ID information identifying the group name to which the apparatus itself belongs in the network, and if applicable, the password, for example, on a HP (homepage); and to hold the group ID and, if applicable, the password.

The information transfer request acceptable/unacceptable information registration unit 1017 has functions to register the information transfer acceptable/unacceptable information specifying whether or not the apparatus accepts the information transfer request from the other information recording/reproducing apparatus belonging to the network, for example, on the HP (homepage); and to hold the information transfer request acceptable/unacceptable information registered.

Subsequently, a description will be given of the detailed operations of the video recording/reproducing apparatus 10 as well as the network-based information recording/reproducing system 1 configured by connecting a plurality of such video recording/reproducing apparatuses.

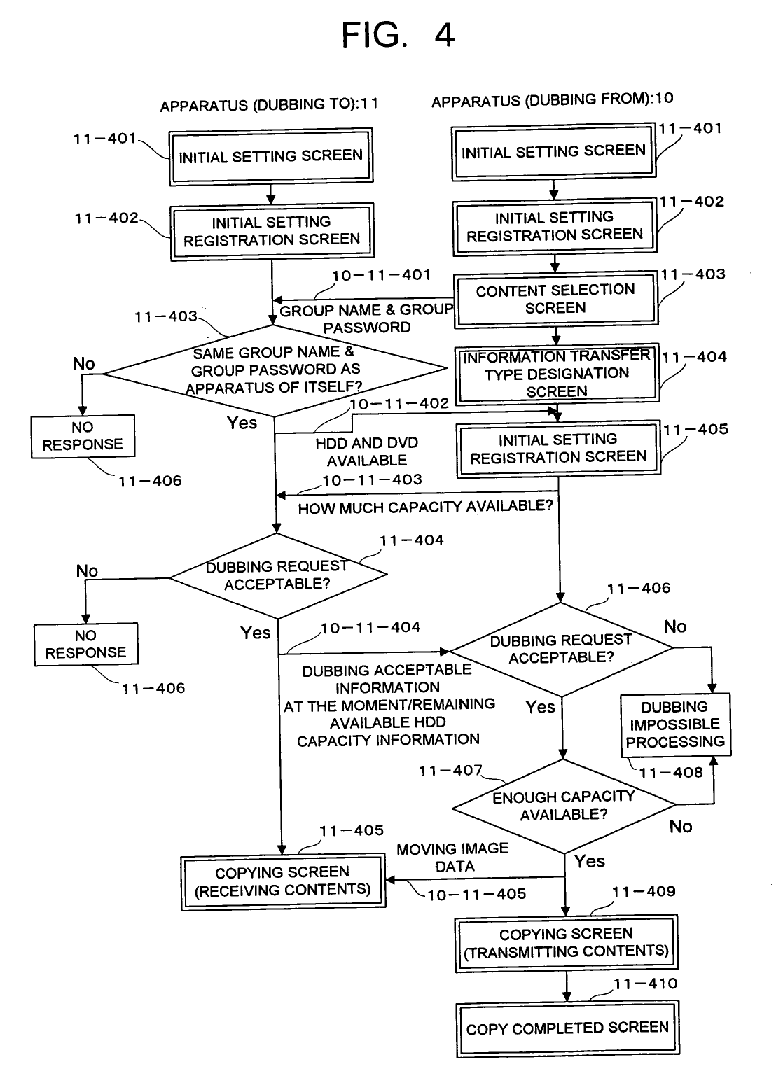

FIG. 4 is a timing and float chart combined with a screen transition chart showing the operations of the video recording/reproducing apparatus and the network-based information recording/reproducing system according to an embodiment of the present invention, together with the order of screens appearing in response to the operations. Note that, here, the outlines of the respective screens are shown in different corresponding drawings. Further, as in the above-stated assumption, the description will be given here on the assumption that the information content is transmitted between the video recording/reproducing apparatus 10 and the video recording/reproducing apparatus 11 shown in FIG. 1, however, the same description and operation are applicable to the case where three or more apparatuses are connected as shown in FIG. 2, as mentioned before. Here, for example, the video recording/reproducing apparatus 10 is assumed to be a transmitter of the information content (apparatus to dub) and the video recording/reproducing apparatus 11 is assumed to be a receiver of the information content (apparatus to be dubbed therein).

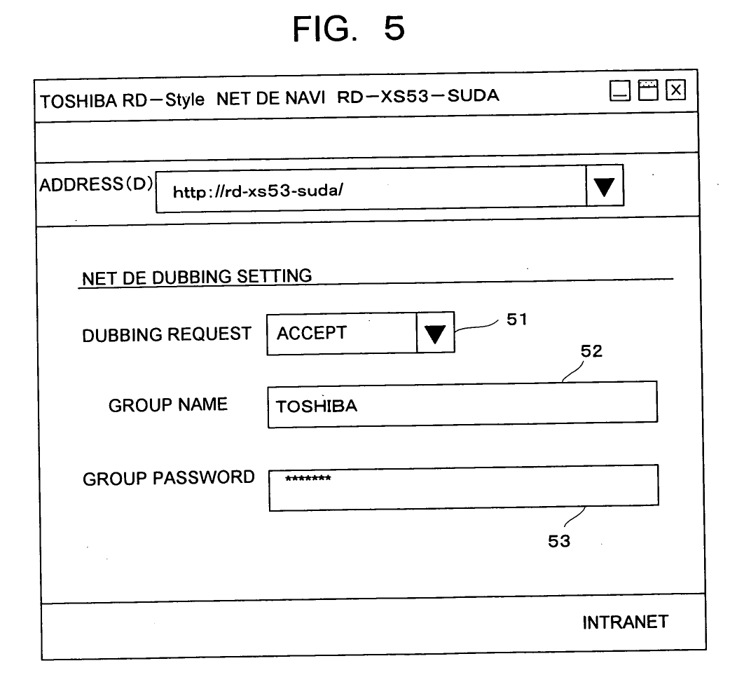

As shown in FIG. 4, first, the main control unit 1010 of the recording/reproducing apparatus 10 displays an initial setting screen as shown in FIG. 5 in a (not shown) monitor (Step 10-401). Specifically, as shown in FIG. 5, the main control unit 1010 displays the screen prompting to input a dubbing acceptable/unacceptable information 51, a group ID information 52, and a group password information 53, respectively, to thereby accept the dubbing acceptable/unacceptable information 51, the group ID information 52, and the group password information 53 inputted by a user (Step 10-401). For instance, in the example in FIG. 5, “accept” is selected and inputted for the dubbing acceptable/unacceptable information 51, “TOSHIBA” is inputted for the group ID information 52, and a predetermined characters or figures of seven digits (for example, “ABCDEFG”) is inputted for the group password information 53, whereas the input of the group password information 53 is displayed as asterisks for security purposes.

Among these inputs, however, the dubbing acceptable/unacceptable information (for example, a flag) 51 can be designated for convenience of the apparatus itself, and when “unacceptable” is selected here, no dubbing of the information content is performed even when the remaining group ID information 52 and the group password information 53 are authenticated. Incidentally, for instance, there may be an usage in which the “acceptable” is set as an initial value at the time of the manufacturing/shipping of the information recording/reproducing apparatus at a plant, and after that, it is changed to “unacceptable” depending on the convenience of the user, for example, when the user has a trouble to receive the information content suddenly transmitted from the others. For the group ID information 52, a social unit needed to share the same information content uses the same group ID information, and, for example, a family sets specific words (here, it is assumed to be, for example, seven characters, however, is not limited thereto) as a group ID for sharing contents among family members, so that the group ID information 52 effects a function to prevent the content from being dubbed to those who do not share the group ID. Further, this is also convenient for the case where a grouping based on the type of information is desired for administrative purpose. The group password information 53 is one of the measures capable of tightening a security control, and the use of this together with the above-described group ID information 52 doubly enables a content dubbing operation with higher security.

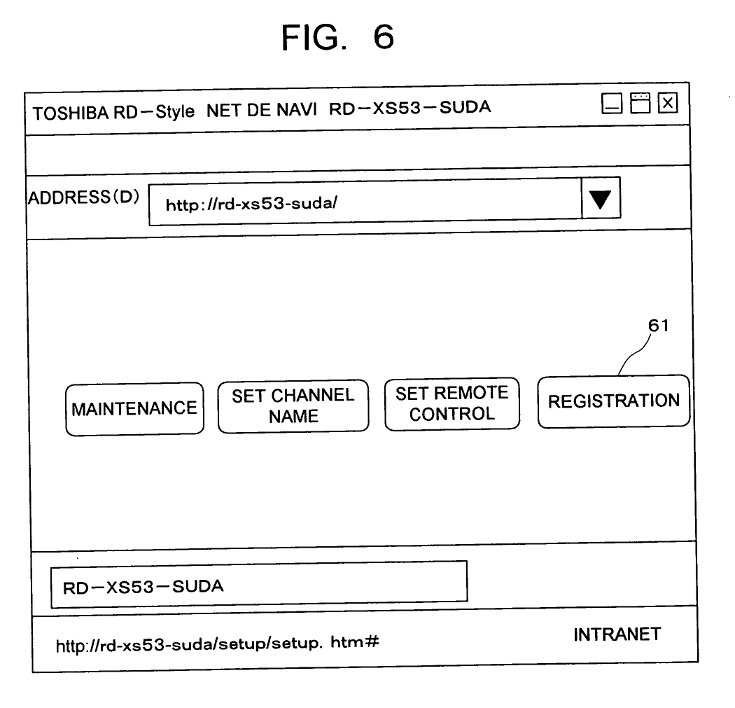

Subsequently, the screen is changed to an instruction input screen (for example FIG. 6) (Step 10-402) for registration of these, and when a registration button 61 is clicked, the above-described dubbing acceptable/unacceptable information 51, group ID information 52, and group password information 53 are recorded into, for example, a (not shown) (nonvolatile) memory (Step 10-402). In FIG. 6, although there is no specific and distinct marking, it is assumed that the “register” button 61 is clicked.

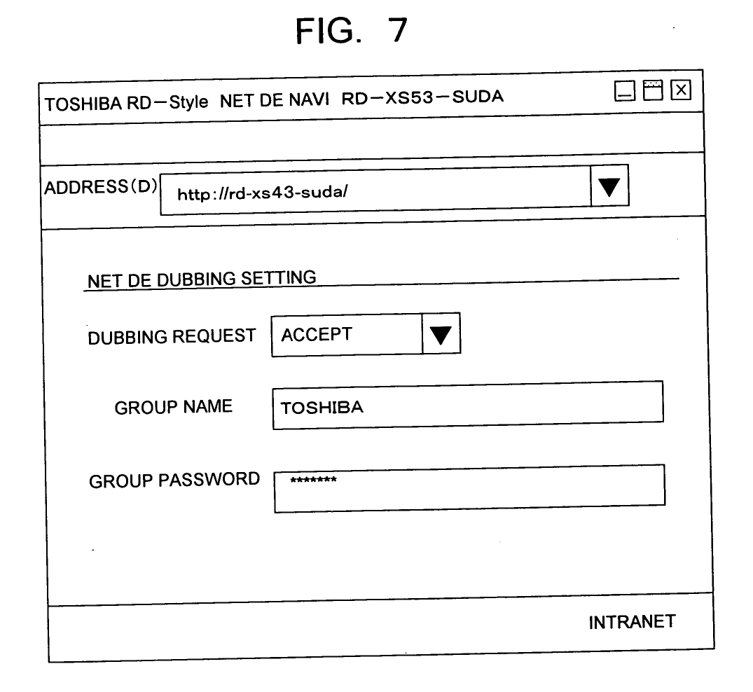

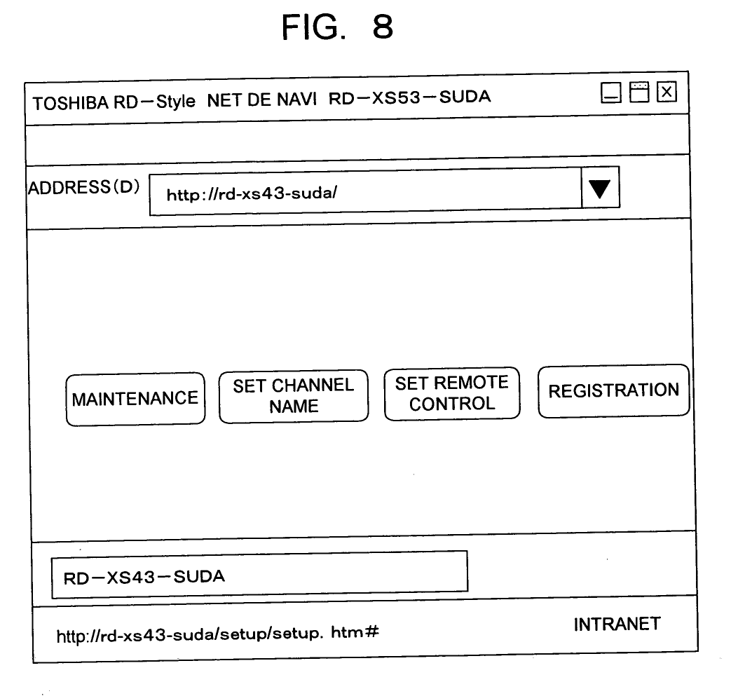

In the meantime, on the side of the recording/reproducing apparatus 11 connected to the network, similarly, the dubbing acceptable/unacceptable information, group ID information, and group password information are prompted to input (Step 11-401) through a display screen such as the initial setting screen as shown for example in FIG. 7, and next, the screen is changed to a registration instruction input screen as shown for example in FIG. 8 to record the inputted dubbing acceptable/unacceptable information, group ID information, and group password information into, for example, a (not shown) (nonvolatile) memory (Step 11-402). Also, here, it is assumed that the same dubbing acceptable/unacceptable information, group ID information, and group password information as inputted at the recording/reproducing apparatus 10 side are inputted, and the registration button is clicked. Briefly, in the example of this section, it is assumed that both the recording/reproducing apparatuses 10, 11 expressed a will to accept a dubbing, have the same group name, inputted appropriate group passwords, and registered these settings.

Note that these initial setting screen and initial setting information registration screen in FIGS. 5 and 6 are set on a HP here. It is possible to set the HP itself a security control. With the security control set to the HP, a system of a higher security level can be built. In other words, as long as it is possible to build a system not allowing any unauthorized person (for example, a person without a predetermined password) to tamper the settings once registered, the screens are not limited to the HP.

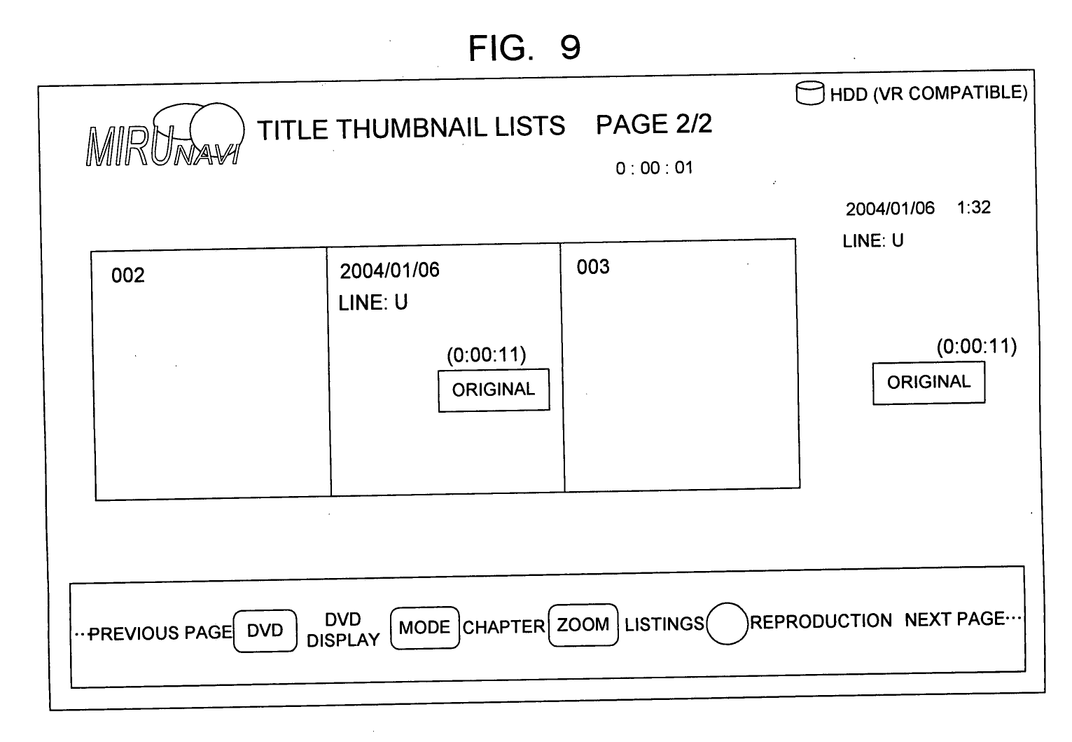

Subsequently, the main control unit 1010 of the recording/reproducing apparatus 10 to dub displays a content selection screen as shown in FIG. 9 in the (not shown) monitor (Step 10-403). Specifically, as shown in the drawing, for example, a screen, in which already recorded contents are split into units and displayed by unit to allow selecting content(s) desired to dub, may be displayed. At this point, the transmitter of the information (namely, a not shown user of the recording/reproducing apparatus 10 to dub) has an option to select contents to transmit.

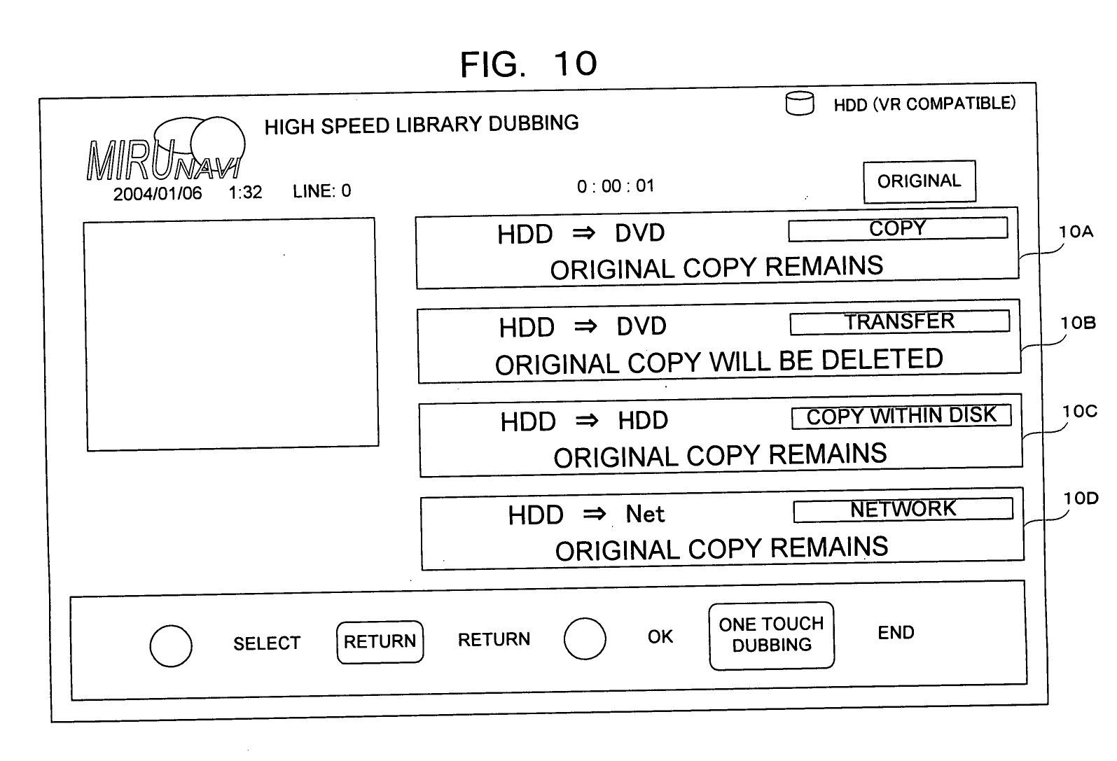

Subsequently, the main control unit 1010 of the recording/reproducing apparatus 10 to dub displays an information transfer type designation screen in the (not shown) monitor (the apparatus side: Step 10-404). When viewing this step from the user side of the recording/reproducing apparatus 10, this step is a step to select/designate the apparatus and the medium (hard disk or DVD) to which the user is going to transmit the information content (Step 10-404). In FIG. 10, an option 10A indicates an option to copy from the HDD to the DVD of the apparatus itself (an original copy is kept as it is), an option 10B indicates an option to transfer from the HDD to the DVD of the apparatus itself (the original copy is deleted), an option 10C indicates an option to copy from a certain area in the HDD to the other area within the same HDD of the apparatus itself (the original copy is kept as it is), and an option 10d indicates an option to copy from a certain area in the apparatus itself to a specific area (record medium) in a destination apparatus via the network (the original copy is kept as it is), respectively. In this example, the description goes on the assumption that the option 10D is selected. Specifically, the dubbing operation of the information content via the network can also be displayed in the screen on the same bases as the other conventional options to copy within the disk or copy/transfer from the HDD to the DVD in the apparatus itself, allowing users to use the network option with a light feeling of just having an new option and without becoming nervous about the technological matters, so that convenience is improved.

Here, the description goes on the assumption that the selection is made in accordance with the user's will to “copy from a certain area in the HDD of the own apparatus to a specific area (record medium) in a specific destination apparatus of the same group via a network” of the option 10D, and the selected option may be highlightened, for example, by being displayed inversely.

Subsequently, the main control unit 1010 of the recording/reproducing apparatus 10 to dub broadcasts via the communication unit 107 toward every apparatuses connected to the network (Step 10-11-401). It is the information transfer request information that is broadcasted.

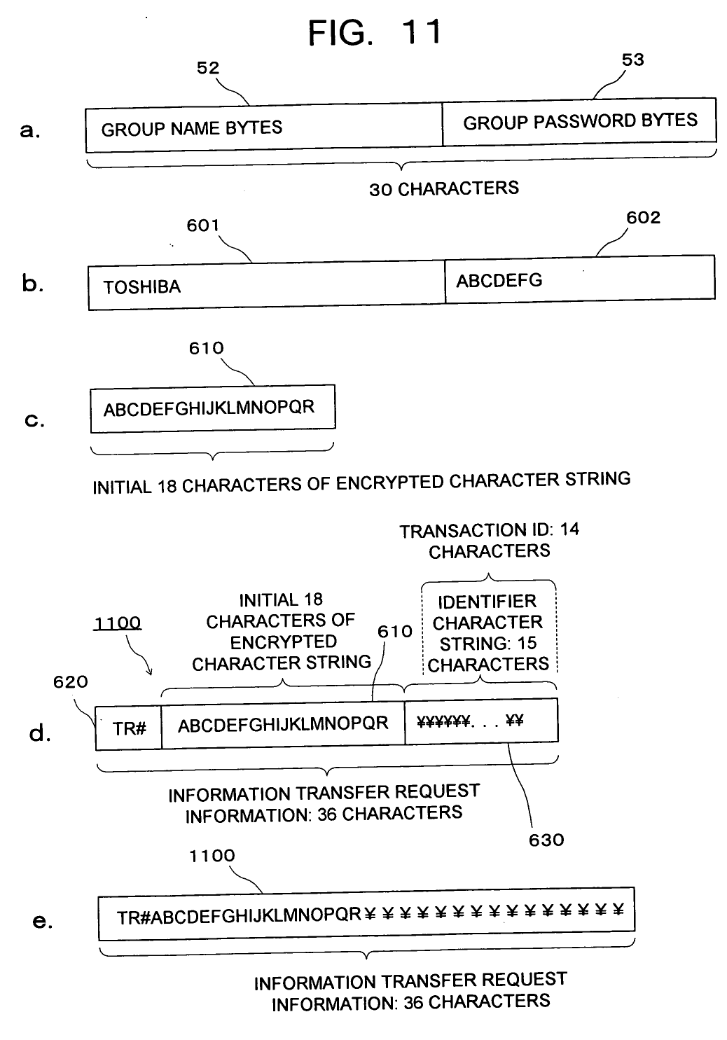

FIG. 11 is a schematic diagram showing a concept of the configuration of the information transfer request information having a configuration specific to the present embodiment, which is to be broadcasted from a content transmitter. As shown in “a.” in FIG. 11, the information transfer request information broadcast unit 1011 generates, first, a character string of, for example, 30 characters by jointing the group ID information 52 and the group password information 53. The length of the character string is assumed to be 30 characters here, whereas any length is acceptable (the same is applicable to the character strings below). In the above-described example, as the group ID information 52, “TOSHIBA” applies, and as the group password information 53, “ABCDEFG” applies, so that the resultant state is as shown in “b.” in FIG. 11.

Subsequently, the information transfer request information broadcast unit 1011 performs a predetermined encryption to the character string thus obtained and adopts, for example, the initial 18 characters thereof (a character string 610 of “c.” in FIG. 11). The information transfer request information broadcast unit 1011 adds a character string 620, for example, “TR#” at the beginning of the character string 610 being the encrypted character string, and an identifier character string 630 (for example, 15 characters) to identify the transmitter of the broadcast at the end thereof (“d.” in FIG. 11). The identifier character string 630 can reduce the possibility that the identifiers of identical character strings are used in the same network to substantially zero (0) by adopting, for example, a random number. Apart thereof, for example, the remaining part of the identifier character string 630 except, for example, the initial one character, (for example, in the above-described case, 14 characters), is defined as a later-described transaction ID. The character string thus obtained (620+610+630) is defined as an information transfer request information 1100 (“e.” in FIG. 11).

The information transfer request information broadcast unit 1011 broadcasts this information transfer request information 1100 to every apparatus related to the network via the communication unit 107 (Step 10-11-401). Note that the information transfer request information 1100 thus broadcasted is saved, for example, in a (not shown) temporary memory.

On the entire information recording/reproducing apparatuses sides connected to the network and receiving the broadcast (here, for example, on the recording/reproducing apparatus 11 side), its (not shown) verification unit 1012a analyses the information transfer request information 1100 broadcasted to verify whether or not the group name and group password thereof are the same as those of itself (Step 11-403). Specifically, a (not shown) information transfer request information broadcast unit 1011a of the recording/reproducing apparatus 11 generates an information transfer request information 1100a related to the own apparatus from the group name and group password registered in the steps of 11-401 to 11-402 of the own apparatus using the methods and procedures shown in FIG. 11 and described above, and the (not shown) verification unit 1012a of the recording/reproducing apparatus 11 compares this information transfer request information 1100a with the information transfer request information 1100 broadcasted thereto (Step 11-403).

At this time, when the information transfer request information 1100 does not matches with the information transfer request information 1100a related to the own apparatus, it is determined that the request is transmitted from the other group, and the recording/reproducing apparatus 11 performs no response (Step 11-406). With this, a transmitting action with the intention of plagiarizing the information content by a person who does not know any one of the group name and group password or the both of them can be prevented from occurring.

On the other hand, when the verification unit 1012a of the recording/reproducing apparatus 11 determines that the information transfer request information 1100 matches with the information transfer request information 1100a related to the own apparatus, a (not shown) information transfer response unit 1013a generates an information transfer response information, and unicasts the generated information transfer response information to the information recording/reproducing apparatus 10 (Step 10-11-402). What to be unicasted is an information transfer response information 1200.

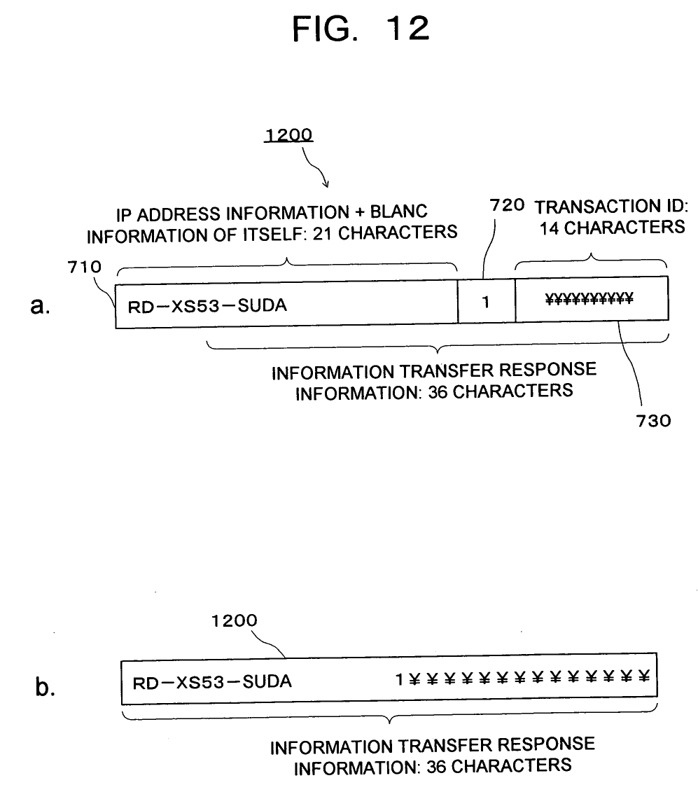

FIG. 12 is schematic diagrams showing a configuration of the information transfer response information 1200 to be unicasted thus from the content receiver and having a configuration specific to the present embodiment. As shown in “a.” in FIG. 12, a (not shown) information transfer response unit 1013a of the recording/reproducing apparatus 11, first, replaces the initial 21 characters (as an example, in the case of FIG. 11) of the information transfer request information 1100, namely the part of the “TR#” character string 620+the encrypted character string 610, with a character string 710 for example of 21 characters formed by a character string for example of 12 characters indicating a host name/IP address of the own apparatus (for example, “RD-XS53-SUDA”) and for example nine blanc characters information.

Subsequently, the (not shown) information transfer response unit 1013a of the recording/reproducing apparatus 11 generates the information transfer response information 1200 formed by 36 characters in total (for example, in accordance with the example in FIG. 11) (FIG. 12B) by continuously adding, to the end of the thus obtained character string, a character string (information medium type information) 720 being an information indicating the type of the own record medium (media) (specifically, whether or not the own apparatus has a HDD/DVD, how many HDD/DVD the apparatus has, and the like)(for example, a single character), and a transaction ID information character string 730 (specifically, an information eliminating one character from the identifier character string 630) (for example, 14 characters) as the remaining characters.

As is clear from the configuration and the generating method, as for the information transfer response information 1200, the part of the “TR#” character string 620+the encrypted character string 610 is enough effected on the unicating party side to confirm whether or not the group name and the group password of the broadcasting side are the same as of the unicasting party, and does not require the unicasting party to dare to transmit back the information (620+610) as it is to the broadcasting side. Since, the broadcasting side can confirm that the group name and the group password are the same with those of the unicasting party by the unicast itself (as described above, the unicasting party performs no response when the group name and the group password are different). That is why the part of 620+610 is replaced with the IP address information (together with blanc) 710.

Further, in order to confirm that the information transfer response information is in response to the request (transaction) that the broadcasting side transmitted, it is not always necessary to use all the random number of the identifier character string 630 (for example, 15 characters), and the part of the random number enough works (the desired purpose can be attained), so that the part thereof (in the above-described case, the first one character of the identifier character string 630) is replaced with the information medium type information 720 of itself. By adopting such a configuration, it is possible to proceed to next step without changing the protocol of the information to be transmitted or received, which is an effect specific to the present embodiment. Further, (as will be described later), the information transfer response information 1200 is configured to contain the information medium type information of itself at the time of the first response, so that a step of inquiring about the medium type to a specified destination after determining the host name/IP address can be eliminated. In other words, it becomes possible to proceed to the subsequent dubbing operation by skipping one step.

The (not shown) information transfer response unit 1013a of the recording/reproducing apparatus 11 unicasts the information transfer response information 1200 to the recording/reproducing apparatus 10 via the communication unit 117 (Step 10-11-402).

On the recording/reproducing apparatus 10 side that received this return, the main control unit 1010 and the verification unit 1012 analyze the information transfer response information 1200 received. Specifically, they recognize that the return is in response to the broadcast they transmitted based on the transaction ID information character string 730 in the information transfer response information 1200, and at the same time, determine the host name/IP address of the unicasting party (the party having the same group name and group password and presumed to be an authentic receiver) based on the IP address information (and blanc) 710, and also the record medium type information of the unicasting party based on the record medium type information 720 (Step 10-405). Specifically, the verification unit 1012, (in the above-described case), compares the last 14 characters of the information transfer response information 1200 with the last 14 characters of the information transfer request information 1100 saved before. When they matches with each other, the group name, group password, and transaction can be determined to be matched, then the main control unit 1010 recognizes the host name/IP address of the unicasting party based on, (in the above-described case), the information indicated by the 12 characters out of from the first character to the 21st character of the information transfer response information 1200, while recognizing the record medium type information of the unicasting party based on the 22nd characters of the information transfer response information 1200, to thereby display these information in the (not shown) monitor of the recording/reproducing apparatus 10.

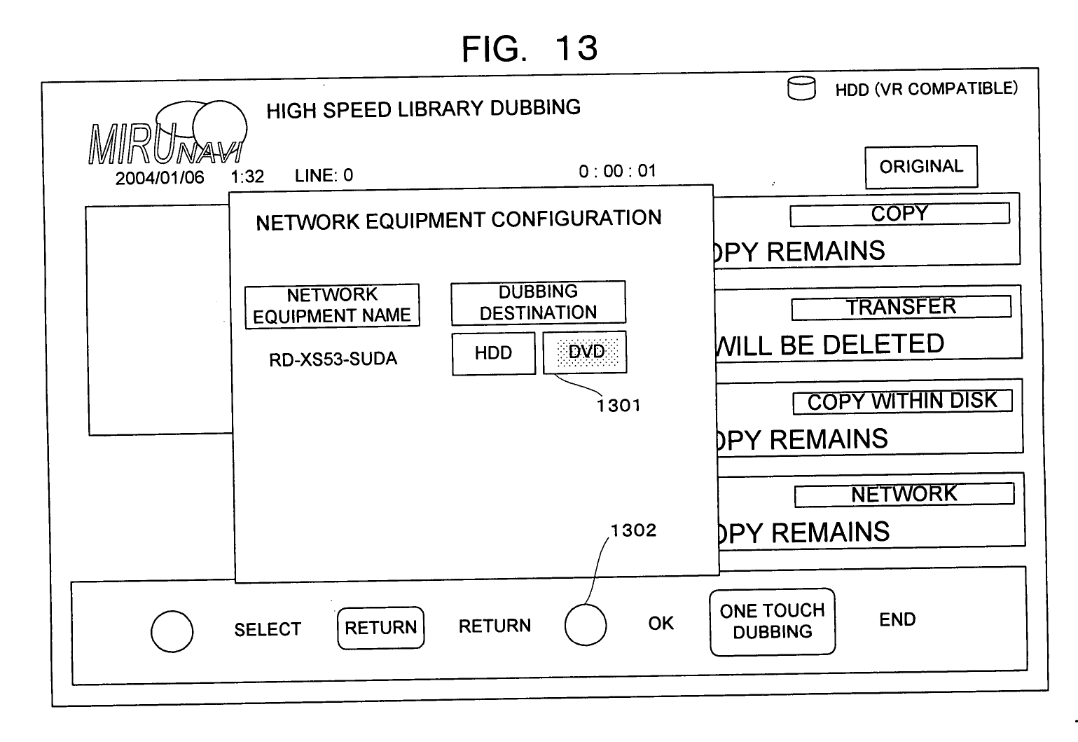

FIG. 13 is a schematic diagram of a screen thus obtained, showing an example display of the host name/IP address information and the record media type information of the opposite party. Specifically, in the example shown in the drawing, the host name/IP address of the opposite party is displayed as “RD-XS53-SUDA”, and the media to be dubbed therein is indicated that both the HDD and DVD are available. Thus, in this screen, the host name/IP address information and the record medium type information of all the presumed authentic receivers having the same group name and group password are displayed. (FIG. 13 shows only one case, contingently). In the screen, the main control unit 1010 prompts the user to select the apparatus to be dubbed therein (namely, the host name/IP address of the apparatus to be dubbed therein) and the record device to be dubbed therein (Step 10-405). In the example shown in the drawing, the “RD-XS53-SUDA” and “DVD” thereof are selected and are, for example, highlightened, (by being inverted or so forth) (1301), which becomes decisive when the confirmation button 1302 is clicked (Step 10-405). Note that this record medium type is not always be singular, and when there are a plurality of HDDs or the like for example the case where one HDD is partitioned into groups, the display may be “HDD1”, “HDD2”, . . . , “HDDn”.

When the apparatus and record device to be dubbed therein are selected by the user, the information transfer response unit 1013 makes an inquiry about the remaining available capacity of the record medium selected, via the communication unit 107, to the recording/reproducing apparatus 11 (Step 10-11-403).

In the recording/reproducing apparatus 11 receiving the inquiry, first, a (not shown) main control unit 1010a determines whether or not to accept the dubbing request (Step 11-404). Specifically, for example, when the apparatus has already accepted a dubbing request from the other apparatus (in the so-called “busy” state), it is determined to be impossible to accept at this moment and makes no response (Step 11-406).

On the other hand, when the apparatus is in a not-busy state, the (not shown) main control unit 1010a acquires the information about the remaining available capacity by making an inquiry to a (not shown) record unit 1015a, and transmits an information that the dubbing request is acceptable at this moment and the acquired information about the remaining available capacity via the communication unit 117 to the recording/reproducing apparatus 10 (Step 10-11-404).

On the recording/reproducing apparatus 10 side, when there is no response for a predetermined period of waiting time, the main control unit 1010 determines that the dubbing request is unacceptable (Step 10-406), and goes to a dubbing impossible processing (Step 11-408). Meanwhile, when the main control unit 1010 receives the information indicating that the dubbing request is acceptable together with the information about the acquired remaining available medium capacity from the recording/reproducing apparatus 11 in the predetermined period of time, the dubbing request is determined to be acceptable (Step 10-406), and after that, the verification unit 1012 compares the obtained remaining available medium capacity information and the content capacity selected in Step 10-403 (Step 10-407).

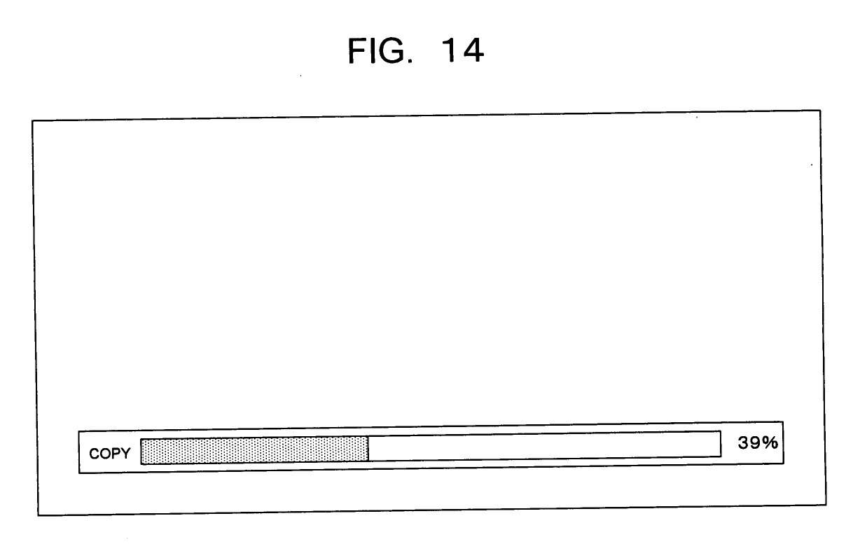

When the remaining available medium capacity of the opposite party is smaller than the required capacity for the content, the verification unit 1012 determines that the dubbing is impossible, and the main control unit 1010 performs the dubbing impossible processing (Step 10-408). Meanwhile, when the remaining available medium capacity of the opposite party is larger than the required capacity for the content, the information content transmission unit 1014 starts transmitting the information content (Step 10-11-405), and at the same time, the main control unit 1010 displays in the (not shown) monitor a progress bar indicating that the content is being transmitted as shown in FIG. 14 (Step 10-409).

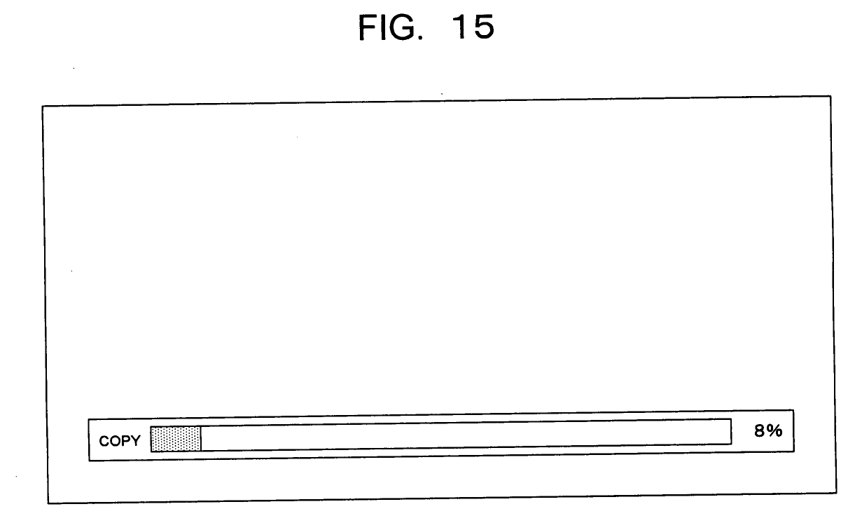

In the mean time, on the recording/reproducing apparatus 11 side to receive the information content transmission (Step 10-11-405), the (not shown) record unit 1015a records the applicable content in the medium specified in the record medium type information transmitted in Step 10-11-404 using the DVD drive 113 or the HDD 115 (Step 11-405), at the same time, the (not shown) main control unit 1010a displays in the (not shown) monitor a progress bar as shown for example in FIG. 15 which indicates that the content is being received (Step 11-405). In the above-described example, when the “DVD” is displayed as a medium type information, the (not shown) record unit 1015a records the applicable content using the DVD drive 113 (Step 11-405).

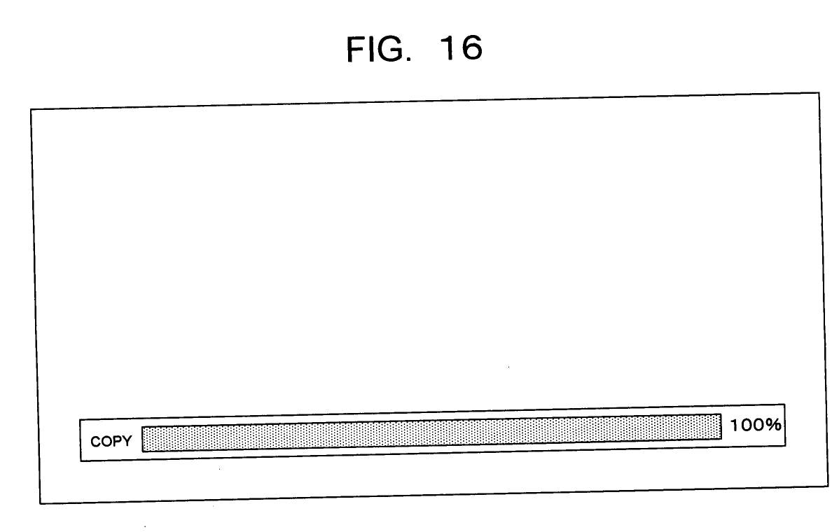

The main control unit 1010 displays in the (not shown) monitor a message indicating the completion of the dubbing (copy), for example, in the form of the progress bar, as shown, for example, in FIG. 16 (Step 10-410).

As described above, according to the present embodiment, the group name and password are registered first, the dubbing requesting party broadcasts the encrypted information based on the group name and password (information transfer request information) to the network, and the information transfer response information(s) is(are) unicasted to the transmitter from only those belonging to the same group, so that the desired content can be transferred to the desired party correctly even under the network to which many apparatuses are connected. Further, the information transfer request information is encrypted by a prescribed method, so that unexpected leakage or plagiarism can be prevented.

Further, according to the present embodiment, the information transfer response information unicasted is formed by replacing a part of the bits of the information transfer request information, so that the dubbing requesting party can proceed to the next step without the need of changing the procedure.

Still further, the information transfer response information contains the transaction ID, so that the dubbing requesting party can recognize that the return is in response to the dubbing request of itself easily.

Furthermore, the information transfer response information uncasted in the first response contains the host name/IP address of the dubbing destination, so that, even when the network has a plurality of apparatuses connected thereto, the determination of the apparatus that unicasted the response information can be made correctly.

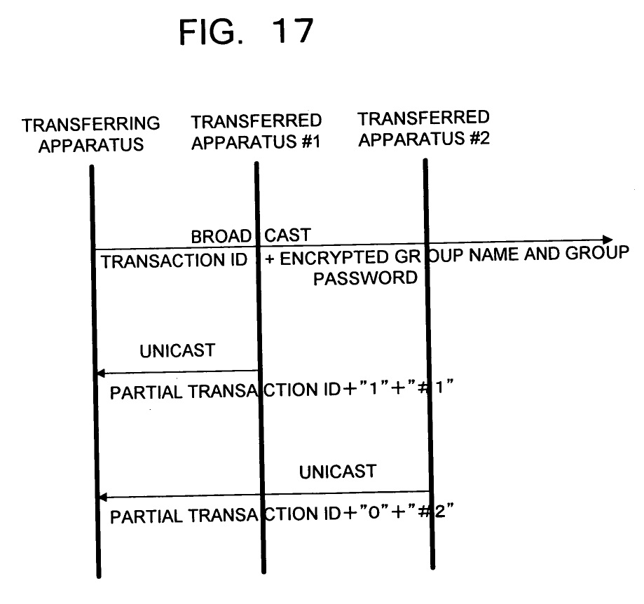

FIG. 17 is a schematic timing chart showing a concept of such a case. As shown in the drawing, a transmitted apparatus #1 and a transmitted apparatus #2 are connected to the network in addition to a transmitting apparatus, and assuming that the transmitted apparatuses #1 and #2 belong to the same group as of the transmitting apparatus, then, in response to the information transfer request information broadcasted from the transmitting apparatus, the transmitted apparatus #1 unicasts to the transmitting apparatus the information transfer response information containing “transaction ID”, “hostname/IP address of itself (for example, “#1”)”, and “record medium information (for example, “1” indicating a HDD). Meanwhile, in response to the information transfer request information broadcasted from the transmitting apparatus, the transmitted apparatus #2 unicasts to the transmitting apparatus the information transfer response information containing “transaction ID”, “host name/IP address of itself (for example, “#2”)”, and “record medium information (for example, “0” indicating a DVD). The transmitting apparatus can distinguish the transmitted apparatus #1 from the transmitted apparatus #2 by the host name/IP address information contained in the information transfer response information returned. This is also applicable to the case where three or more apparatuses are connected to the network.

Furthermore, according to the present embodiment, the information transfer response information to be unicasted contains the media type, so that the dubbing requesting party can proceed to the next step after easily recognizing that the response is in response to the dubbing request of itself, without having a step to inquiry again about the dubbing device type after determining the apparatus as the dubbing destination.

As has been described above, the present embodiment can be recognized as a network-based information recording/reproducing system, an information transmission destination retrieval method capable of detecting an apparatus that can be dubbed a video content therein, or further an information recording/reproducing apparatus.

Note that the present invention is not limited to the above-described respective embodiments and may be modified in various forms within the technical spirit of the present invention.

For instance, the above-described encryption is applicable by any method as long as it can improve security.

Further, for example, the above description assumes that the information transfer request information and the information transfer response information have specific bytes, however, the number of the bytes are not limited thereto, and the technical spirit of the present invention is applicable in any form as long as the bit number can be the same, the partial replacement can be made, the transaction ID can be held, the host name/IP address are interfusable, and the record media information is interfusable, between or in the information transfer request information to be broadcasted and the information transfer response information to be unicasted.

Furthermore, the present invention allows various modification, addition, replacement, expansion, reduction, and so forth within the same and equivalent scope as/to the technical spirit of the present invention. Further, even when an apparatus, method, software, or system that is produced using the present invention is commercialized by being mounted in a secondary product, the fact in no case reduces the value of the present invention.

It is understood that the present invention is not limited to specific embodiments described herein with reference to the drawings, and that modifications included in the scope of the claims described hereinafter are all within the scope of the present invention.

1. A network-based information recording/reproducing system having a plurality of information recording/reproducing apparatuses connected via a network to transmit/receive information including video among the information recording/reproducing apparatuses, each of the information recording/reproducing apparatuses being provided with at least a central processing unit (CPU), first and/or second information medium device(s), and a communication unit, the system comprising:
a first recording/reproducing apparatus being a transmitter of the information that transmits an information transfer request information containing a transaction ID to the information recording/reproducing apparatus (es) connected via the network other than the first recording/reproducing apparatus itself, and also transmits an information content to a second information recording/reproducing apparatus identified by an IP address information contained in an information transfer response information returned; and
the second information recording/reproducing apparatus applicable to an information transfer request out of the information recording/reproducing apparatuses receiving the information transfer request information, the second information recording/reproducing apparatus transmitting an information transfer response information containing the transaction ID, the IP address information of the second information recording/reproducing apparatus, and an information medium type information indicating a type of the information medium device to the first information recording/reproducing apparatus, and also recording the information content transmitted by the first information recording/reproducing apparatus into the first or second information medium specified by the information medium type information.

2. A network-based information recording/reproducing system as set forth in claim 1,
wherein each of the information recording/reproducing apparatuses belonging to the network registers, prior to transmitting the information transfer request information, a group ID information identifying a group name, the group involving the information recording/reproducing apparatus,
wherein the information transfer request information contains the group ID information, and
wherein the second information recording/reproducing apparatus receiving the information transfer request information tranmitted thereto transmits the information transfer response information to the first information recording/reproducing apparatus only when the group ID information in the information transfer request information matches with the group ID information registered by the second information recording/reproducing apparatus itself.

3. A network-based information recording/reproducing system as set forth in claim 1,
wherein each of the information recording/reproducing apparatus belonging to the network registers, prior to tranmitting the information transfer request information, an information transfer request acceptable/unacceptable information specifying whether or not to accept the information transfer request from other apparatus, and
wherein the second information recording/reproducing apparatus receiving the information transfer request information transmitted thereto transmits the information transfer response information to the first information recording/reproducing apparatus only when the information transfer request acceptable/unacceptable information registered by the second information recording/reproducing apparatus itself indicates acceptable.

4. A network-based information recording/reproducing system as set forth in claim 1,
wherein the information transfer response information is obtained by replacing a specified bit of the information transfer request information with a bit related to an information medium type information.

5. A network-based information recording/reproducing system as set forth in claim 1,
wherein the information transfer response information and the information transfer request information are encrypted by a prescribed encryption method.

6. An information transmission destination retrieval method specifying a transmission destination to transmit an information content to an information recording/reproducing apparatus connected via a network and provided with at least a central processing unit (CPU), first and/or second information medium device(s), and a communication unit, the method comprising:
transmitting an information transfer request information containing a transaction ID to the network;
receiving an information transfer response information containing the transaction ID together with an IP address information and an information medium type information indicating a type of the information medium device that are related to the information recording/reproducing apparatus responding to the information transfer request information transmitted thereto; and
specifying the information recording/reproducing apparatus as a transmission destination of information and the information medium device related to the information recording/reproducing apparatus, based on the transaction ID contained in the information transfer response information.

7. An information recording/reproducing apparatus provided with at least a central processing unit (CPU), first and/or second information medium device(s), and a communication unit,
wherein the central processing unit comprises:
an information transfer request information broadcast means for transmitting via the communication unit an information transfer request information containing a transaction ID for an information content transmission to another information recording/reproducing apparatus connected therewith via a network;
a verification means for verifying the transaction ID contained in the information transfer request information received via the communication unit;
an information transfer response means for transmitting an information transfer response information containing the transaction ID, an IP address information of itself, and an information medium type information indicating a type of the information medium device, to an information recording/reproducing apparatus being a transmitter of the information transfer request information, when the information transfer request information is verified to be applicable to itself by the verification means;
an information content transmission means for transmitting an information content to the information recording/reproducing apparatus being a transmission destination specified by the IP address information contained in the information transfer response information received; and
a record means for recording the transmitted information content into a first or second information medium specified by the information medium type information.

8. An information recording/reproducing apparatus as set forth in claim 7,
wherein the central processing unit further comprises a means for registering a group ID information identifying a group name in the network, the group involving the apparatus itself,
wherein the information transfer request information contains the group ID information, and
wherein the information transfer response means transmits the information transfer response information to the information recording/reproducing apparatus being a tansmitter of the information transfer request information, only when the group ID information in the information transfer request information received matches with the group ID information registered by the apparatus itself.

9. An information recording/reproducing apparatus as set forth in claim 7,
wherein the central processing unit further comprises a means for registering an information transfer request acceptable/unacceptable information specifying whether or not to accept the information transfer request from another information recording/reproducing apparatus belonging to the network, and
wherein the information transfer response means transmits the information transfer response information to the information recording/reproducing apparatus being the transmitter only when the information transfer request acceptable/unacceptable information indicates acceptable.

10. An information recording/reproducing apparatus as set forth in claim 7,
wherein the information transfer response information is obtained by replacing a specified bit of the information transfer request information with a bit related to an information medium type information.

11. An information recording/reproducing apparatus as set forth in claim 7,
wherein the information transfer response information and the information transfer request information are encrypted by a prescribed encryption method.
